(19) United States
(12) Patent Application Publication
(10) Pub. No.: US 2025/0091296 A1
(43) Pub. Date: Mar. 20, 2025

(54) IMPROVED ACCORDION SUPPORTS AND METHOD OF PRINTING THEREOF

(71) Applicant: MARKFORGED, INC., Waltham, MA (US)

(72) Inventors: Andrew Braverman, Waltham, MA (US); Elizabeth Keller, Waltham, MA (US)

(21) Appl. No.: 18/888,345

(22) Filed: Sep. 18, 2024

Related U.S. Application Data
(60) Provisional application No. 63/539,439, filed on Sep. 20, 2023.

(51) Int. Cl. B29C 64/40; B29C 64/118; B29C 64/386; B33Y 10/00; B33Y 50/00; B33Y 80/00

(52) U.S. Cl. CPC B29C 64/40; B29C 64/118; B29C 64/386; B33Y 10/00; B33Y 50/00; B33Y 80/00

(57) ABSTRACT

Methods of printing parts, e.g., using a 3D printer, are disclosed. The methods include receiving a representation of a part to be printed. The methods include analyzing the representation along one or more of an X-Y plane, X-Z plane, and Y-Z plane to identify locations of the part where the one or more supports are needed. The methods include depositing a first layer of the one or more supports at a first spacing. The methods further include depositing a second layer of the one or more supports at the first spacing. The methods additionally include repeating the deposition of additional layers of the one or more supports. The methods include printing the part onto the one or more supports.

### CROSS REFERENCE TO RELATED APPLICATIONS

This application claims priority under 35 U.S.C. § 119 (e) to U.S. Provisional Application Ser. No. 63/539,439 titled “ACCORDION SUPPORTS AND METHOD OF PRINTING THEREOF” filed on Sep. 20, 2023, the contents of which is herein incorporated by reference in its entirety.

### FIELD OF TECHNOLOGY

Aspects and embodiments disclosed herein relate to methods for improved supports for 3D printing.

### SUMMARY

In accordance with an aspect, there is provided a method of printing a part. The method may include receiving a representation of a part to be printed. The method may include analyzing the representation along one or more of an X-Y plane, X-Z plane, and Y-Z plane to identify locations of the part where the one or more supports are needed. The method further may include depositing a first layer of the one or more supports at a first spacing. The method may include depositing a second layer of the one or more supports at the first spacing. The method further may include repeating the deposition of additional layers of the one or more supports. The method additionally may include printing the part onto the one or more supports.

In some embodiments, the first spacing may be at least 1 mm. In further embodiments, the first spacing may be at least 8 mm. For example, the first spacing may be between 10 mm to 15 mm.

In some embodiments, a spacing of the one or more supports may be decreased at an interface where the part is to be printed. In some embodiments, the spacing of the one or more supports at the interface where the part is to be printed may be at least 0.5 mm. In other embodiments, the spacing of the one or more supports at the interface where the part is to be printed may be between 0.5 mm and 10 mm. For example, the spacing of the one or more supports at the interface where the part is to be printed may be about 2.5 mm.

In some embodiments, the one or more supports may have a layer thickness between 1 μm to 1000 μm. In further embodiments, the one or more supports may have a layer thickness between 50 μm to 500 μm. For example, the one or more supports may have a layer thickness between 125 μm to 250 μm.

In some embodiments, the second layer may be rotated in a direction orthogonal to the first layer of the one or more supports.

In accordance with an aspect, there is provided a method of printing a part with one or more supports. The method may include analyzing the representation along one or more of an X-Y plane, X-Z plane, and Y-Z plane to identify locations of the part where the one or more supports are needed. The method further may include depositing a first layer of the one or more supports at a first spacing. The method may include depositing a second layer of the one or more supports at the first spacing. The second layer may be rotated in a direction orthogonal to the first layer of the one or more supports. The method additionally may include printing the part onto the one or more supports.

In some embodiments, the second layer rotated in a direction orthogonal to the first layer of the one or more supports. In certain embodiments, every successive layer is rotated in a direction orthogonal to the previously deposited layer of the one or more supports.

In accordance with an aspect, there is provided a method of printing a part with one or more supports. The method may include analyzing the representation along one or more of an X-Y plane, X-Z plane, and Y-Z plane to identify locations of the part where the one or more supports are needed. The method further may include depositing a first layer of the one or more supports at a first spacing. The method may include depositing a second layer of the one or more supports at the first spacing. The second layer may be rotated in a direction orthogonal to the first layer of the one or more supports. The method further may include repeating the deposition of additional layers of the one or more supports. A spacing of the one or more supports may be decreased at an interface where the part is to be printed. The method additionally may include printing the part onto the one or more supports.

In accordance with an aspect, there is provided a method of printing a part. The method may include receiving a representation of a part to be printed. The method may include analyzing the representation along one or more of an X-Y plane, X-Z plane, and Y-Z plane to identify locations of the part where the one or more supports are needed. The method further may include depositing a first layer of the one or more supports at a first spacing. The method may include depositing a second layer of the one or more supports at the first spacing. The second layer may be rotated in a direction orthogonal to the first layer of the one or more supports. The method further may include repeating the deposition of additional layers of the one or more supports. The method additionally may include printing the part onto the one or more supports.

In some embodiments, the second layer rotated in a direction orthogonal to the first layer of the one or more supports. In certain embodiments, every successive layer is rotated in a direction orthogonal to the previously deposited layer of the one or more supports.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates a schematic of a part having both fine supports and two types of coarse supports, according to methods of this disclosure;

FIGS. 2A-2C illustrate a small part printed with supports using the methods of this disclosure. FIG. 2A illustrates the part sitting on top of the support tower printed using no rotations and typical support spacing. FIG. 2B illustrates a bottom side view of supports printed using methods of this disclosure. FIG. 2C illustrates the bed adhesion interface of the supports printed using methods of this disclosure;

FIG. 3 illustrates a comparison of a part and supports printed using methods of this disclosure and the equivalent volume of material printed using traditional support methods; and

FIGS. 4A-4C illustrate a part and supports printed using methods of this disclosure. FIG. 4A illustrates the structure of the supports. FIG. 4B illustrates the structure of the part being supported. FIG. 4C illustrates the part's internal structure.

The features and advantages of the disclosure are apparent from the detailed specification, and thus, it is intended that the appended claims cover all systems and methods falling within the true spirit and scope of the disclosure. As used herein, the indefinite articles “a” and “an” mean “at least one” or “one or more.” Similarly, the use of a plural term does not necessarily denote a plurality unless it is unambiguous in the given context. Words such as “and” or “or” mean “and/or” unless specifically directed otherwise. In this application, the terms “comprising” and “including” may be understood to encompass itemized components or steps whether presented by themselves or together with one or more additional components or steps. Unless otherwise stated, the terms “about” and “approximately” may be understood to permit standard variation as would be understood by those of ordinary skill in the art. Where ranges are provided herein, the endpoints are included. As used in this application, the term “comprise” and variations of the term, such as “comprising” and “comprises,” are not intended to exclude other additives, components, integers or steps.

As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Many methodologies described herein include a step of “determining.” Those of ordinary skill in the art, reading the present specification, will appreciate that such “determining” can utilize or be accomplished through use of any of a variety of techniques available to those skilled in the art, including for example specific techniques explicitly referred to herein. In some embodiments, determining involves manipulation of a physical sample. In some embodiments, determining involves consideration and/or manipulation of data or information, for example utilizing a computer or other processing unit adapted to perform a relevant analysis. In some embodiments, determining involves receiving relevant information and/or materials from a source. In some embodiments, determining involves comparing one or more features of a sample or entity to a comparable reference.

As used herein, the term “substantially,” and grammatic equivalents, refer to the qualitative condition of exhibiting total or near-total extent or degree of a characteristic or property of interest. One of ordinary skill in the art will understand that chemical phenomena rarely, if ever, go to completion and/or proceed to completeness or achieve or avoid an absolute result.

### DETAILED DESCRIPTION

Additive manufacturing, sometimes more generally known as three-dimensional printing, refers to a class of technologies for the direct fabrication of physical products from a three-dimensional computer model by a layered manufacturing process. In contrast to material removal processes in traditional subtractive manufacturing, the three-dimensional printing process adds material. In additive manufacturing, 3D parts are manufactured by adding layer-upon-layer of material. For example, an additive manufacturing-based 3D printing device can create a 3D part, based on a digital representation of the part, by depositing a part material along toolpaths in a layer-by-layer manner. This process can enable the direct printing of products with extremely complex geometry.

Fused Deposition Modeling (FDM), also referred to as Fused Filament Fabrication (FFF), is an example of additive manufacturing technology used for modeling, production, and prototyping. In an FDM or FFF additive manufacturing process, a moving print head deposits a filament of material onto a print bed or to an object being printed. The print head and/or the print bed can move relative to each other under computer control to define the printed object. Additive manufacturing of a layer generally involves slicing a two-dimensional layer into a series of shells, that is beads, lines, or shells that are stacked on top of one another (that is, along the Z-axis) forming a digital representation of the intended part. The printing of a layer is typically done shell-by-shell on a build plate or print bed until the one or more shells (i.e., the plurality of shells) are complete, e.g., by incrementing the position of the print head relative to the build plate or print bed along one or more print axes. For example, each two-dimensional layer may have a number of shells lining a contour, such as a perimeter of a wall. This process can then be repeated to form an object, i.e., a three-dimensional part, resembling the digital representation. The process of depositing shells is typically in a machine-controlled manner according to slicing parameters. Additionally, for example, printing of subsequent shells may include depositing by tracing along a contour or path defined by a prior printed shell. A result of such a process can be a repeatable and consistent deposition. Moreover, each two-dimensional layer may have a different fill pattern filling the interior of the part. Additionally, a fill pattern may be deposited between an inner and an outer perimeter of a wall.

In an FDM or FFF manufacturing system, a three-dimensional part or model may be printed from a digital representation of the three-dimensional part in a layer-by-layer manner by depositing part material along toolpaths.

The print head can move in two dimensions to deposit part material in one horizontal plane or a layer of the object being printed. Then, the print head or the print bed can be moved vertically by a small amount to begin another horizontal plane, a new layer of the object. The part material is deposited through a nozzle carried by a print head of a three-dimensional printing apparatus, device, or system. Part material is deposited as a sequence of roads on a substrate in a build plane. A layer, for example, a first layer of a printable material is deposited onto the build surface. That is, for example, a horizontal layer is printed with movement in the X-Y axis. Once this first horizontal layer is completed, a height adjustment is made in the Z-axis and another horizontal layer can be printed with movement in the X-Y axis. Once the next horizontal layer is completed, another height adjustment is made in the Z-axis. This process continues, for each layer until the object is completed. When depositing the layers of the part material, the print head applies a downward force to the part material with the nozzle. This downward force, in conjunction with the heat applied by the print head to the nozzle, can act to secure the part material to the structure it is applied to, e.g., a build platen or a preceding layer of the part material.

Parts manufactured using 3D printing and other additive manufacturing techniques often have complex geometries and features that that span open distances, such as ledges, beams, and the like. In order to properly create parts with these features, supports are often made before the feature is printed. The use of supports in general allows printing features that would typically be subject to poor adhesion or failure due to gravity, geometry, or otherwise. Without wishing to be bound by any particular theory, supporting material is typically applied when a print feature has a threshold angle of any surface deviating relative to vertical of an angle of 45 degrees or greater. Placing a support material underneath such a features reduces printing failures, such as part warping, sagging, or detaching from the print bed or build platen.

There are a number of considerations to be made when supports are incorporated into the design and printing of part. First, the placement of the supporting material should allow printing material that sags, i.e., due to gravity, to have a maximum amount of movement before it hits the support, i.e., the part that sags should not sag beyond the supporting material. Second, the attachment of the supporting material to the part should be sufficiently secure such that it prevents any upward curling of the part surface. Without wishing to be bound by any particular theory, upward curling of 3D printed parts may arise from material stresses in the filamentary material that is deposited under heat and pressure. These material stress effects result in printing material that can detach from a previously deposited layer or from a print bed or build platen, resulting in parts that include voids between layers or are otherwise out of specification once completed. Third, the attachment of the supporting material to the part should be sufficiently weak such that the supporting material can be pulled away with relative case and leave minimal surface marring to the finished part. Supports can attach in any suitable location on the part that will provide the needed rigidity during a production process. Supports can generally be attached to the print bed or build platen or can be attached to a top side of the parts, such as an overhanging surface of a part.

In at least one embodiment, supports are printed in an accordion or bellows pattern over the full dimensions of a part. While able to provide adequate support, accordion or bellows supports have a number of disadvantages for both the printing process and resulting part. For example, accordion supports are not well suited to the printing of larger parts that may become radially or directionally unstable as printing proceeds as the accordion is generally flexible and will follow any defects in the printed part. Accordion supports, as they are generally full part supports, can use a considerable amount of printing material and can be slow to print, often taking longer to print than the part itself. Accordion supports can also be subject to the effects of airflow, i.e., the large surface area of accordion supports increases the probability of the support warping when contacted by air during a sintering or heating process. It is an object of this disclosure to provide for a method of printing supports that provide adequate rigidity with reduced material usage and increased printing speed.

An approach to improving accordion supports is to use two or more different support densities as part of the printing process. As disclosed herein, a method of printing parts may include printing a series of supports that have increased spacing between each support at distances further from the part, i.e., coarse supports. For example, at distances further away from the center of mass of a part, the support can be printed with portions further spaced apart. The spacing between support can be decreased at the interface of the part and support. Without wishing to be bound by any particular theory, the spacing between supports, whether fine or coarse, can vary depending on the part layer height and on the structural details or feature of the part being supported. In some embodiments, the spacing between supports can be at least 1 mm, e.g., about 1 mm, about 2 mm, about 3 mm, and so on. In further embodiments, the spacing between supports can be at least 8 mm, e.g., at least 8 mm, at least 9 mm, at least 10 mm, etc. In further embodiments, the spacing between supports can be between 10 mm and 15 mm. As a non-limiting example, coarse supports with wider spacing can have a spacing between layers of about 8 mm and a spacing of about 2.5 mm at the interface of the part and the support. As another non-limiting example, the transition between coarse support and fine support can be abrupt, e.g., only supports at an immediate interface of the part and the remainder of the supports printed using coarse spacing. In some embodiments, coarse supports can be printed every other layer of a part, as opposed to being printed for every layer of the part, e.g., to increase print speed and decrease material usage.

When the spacing of the one or more supports decreases at an interface where the part is to be printed, the spacing may be at least 0.5 mm. In some embodiments, the spacing of the one or more supports at the interface where the part is to be printed is between 0.5 mm and 10 mm. For example, the spacing of the one or more supports at the interface where the part is to be printed is about 2.5 mm.

As disclosed herein, there are provided methods of printing parts with one or more supports. The methods include receiving a representation of a part to be printed and analyzing the representation along one or more of a coordinate plane, i.e., an X-Y plane, X-Z plane, and Y-Z plane to identify locations of the part where the one or more supports are needed. The methods include depositing a first layer of the one or more supports at a first spacing. The methods include depositing a second layer of the one or more supports at the first spacing. The methods further include repeating the deposition of additional layers of the one or more supports. The deposition of additional support layers of the one or more supports can be printed, with the part being printed onto the one or more supports. In some embodiments, the support spacing is decreased at the projected interface with the part and support, i.e., printing fine supports. In further embodiments, the second layer of the one or more supports is rotated in a direction orthogonal to the first layer of the one or more supports. In certain embodiments, printing a part with one or more supports includes supports with wider spacing deposited rotationally, with decreased spacing supports deposited at the projected interface of the part and supports.

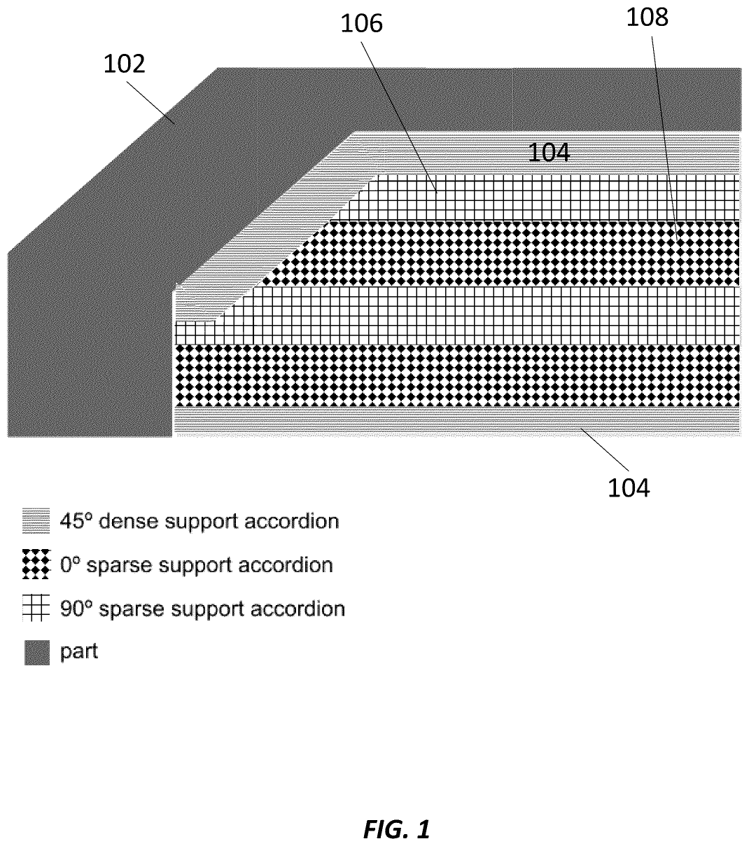

Finer or non-coarse supports as disclosed herein are preferentially disposed closest to the part, e.g., at the interface of the part and the supports and/or at a lower portion of the support block as illustrated in FIG. 1, to provide for support uniformity at the interface of the part, e.g., to increase the supportive effects, and to provide for case of removal. Finer or non-coarse supports as disclosed herein further can be used to bridge over a grid-type pattern above coarse supports while being printed at any practical angle relative to the part. As there will be reduced contact surface area in bridging over a wide spaced grid typical of the coarse supports, the finer or non-coarse supports will adhere as normal to the part while having facile removal. Further, finer or non-coarse supports as disclosed herein, when backed by coarse supports, can be printed with an adjustable layer thickness at the interface of the part and support.

In some embodiments, coarse supports, e.g., supports with a wider or increased spacing between layers, can be printed using rotations of the part at an interval. The direction of rotation is typically orthogonal between deposited layers. Without wishing to be bound by any particular theory, the addition of rotations at periodic intervals into the supports can increase the rigidity of the support. For example, in some embodiments, the support can be rotated about 45 degrees to about 90 degrees every layer to increase the rigidity of the support along the length of the support. An example of this is illustrated in FIG. 1, where the part includes high density supports rotated at 45 degrees with the remaining supports being low density and rotated either 0 degrees or 90 degrees. In FIG. 1, the support can be rotated 45 degrees closest to the center of mass of the part 102 being printed. In this configuration, the 45-degree support 104 is printed with a fine spacing, i.e., increased filament density, closest to the part. The remaining supports for the part 102 can be printed with coarser spacing and rotations of 0 degrees (support 108) to 90 degrees (support 106). The rotation of the supports can be at a fixed interval, such as every support layer, every other support layer, or every n layers, with n=2-50. The rotation interval is determined, in part, by the design of the part and a projected amount of support the part will need during printing.

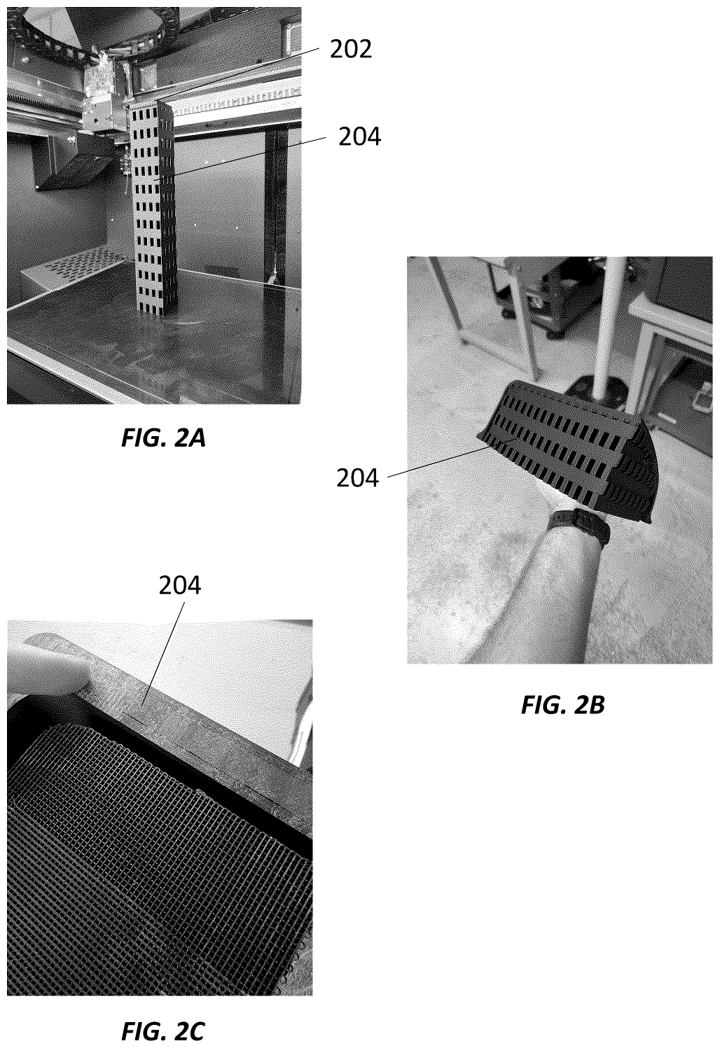

In the embodiments of variable supports disclosed herein, there are variables that can be adjusted before and/or during a printing process to optimize the supports for a specific part being printed. For example, the number of layers of the finer or more dense supports and the specific locations can be selected based on the part being printed. Another variable that is to be optimized is the density of both the fine and coarse supports. In general, the density of any support, whether fine or coarse, is a function of the spacing of the support, the material feed rate from the printer, and the width of the material layer being printed as the support. In addition, the interval at which the coarse supports changes angle by 90°, i.e., the accordion shape supports illustrated in FIGS. 2A-2C, can be adjusted by the choice of how many layers to print before making the angle change.

As disclosed herein, a method of printing a part with supports can include both increasing the spacing between the coarse supports further away from the part and rotating the supports to increase rigidity. By increasing the spacing of accordions during the depositing of coarse supports, material and time can be saved and by adding rotations to the accordions, rigidity can be added to the supports. As a non-limiting example, a 125 μm support layer height in the Z-direction can reliably bridge at least 10 mm accordion spacing between support layers. In another non-limiting example, a 250 μm support layer height in the Z-direction can reliably bridge at least 15 mm accordion spacing between support layers. In typical 3D printings, rotation of the printing of supports occurs on the order of every 10 mm of support, with support layers having a thickness of between about 10 μm to about 1000 μm. For example, the support layers can have a thickness of about 50 μm to about 250 μm, e.g., about 125 μm to about 250 μm. To increase rigidity, the rotation interval for printing support is increased to every support layer. In this configuration, each support layer changes direction and thus reduces the stepover for the first few layers of the support. As used herein, “stepover” refers to the spacing between consecutive beads, e.g., concentric fills or solid raster fills. This reduction in stepover results in a tightly spaced accordion support attached to the print bed or build platen, thereby increasing bed adhesion for the supports.

Printing of supports using methods disclosed herein, i.e., variable support spacing based on distance to part and support rotation every layer, offers a number of benefits over existing support printing methods and geometries. Printing supports with the methods disclosed herein uses less material by up to about 75% for a fixed part geometry over existing methods. The use of less material translates into reduced costs to a user or operator and reduced printing time as it takes less time to print less material at a specified feed rate. The use of less material and reduced printing time further provides for an increase in printer reliability as there are less opportunities for printer errors. The coarseness of the supports in select areas of the part provides for facile support removal with no reduction in part quality. The supports printed using methods disclosed herein, do not alter the surface finish of the resulting parts and thus provide for an improvement in overall part quality. The rotation imparted to the supports increases the vertical strength of the supports and provides for increased predictability of support structures for complex geometries. The support printing methods disclosed herein do not require any additional or different printer hardware than existing printer technologies and can be incorporated directly into controllers as an update.

### EXAMPLES

The function and advantages of these and other embodiments can be better understood from the following examples. These examples are intended to be illustrative in nature and are not considered to be in any way limiting the scope of the invention.

### Example 1

In this example, a square part was printed on top of a tower support. The support was printed using typical printer settings with consistent spacing throughout the support and no rotations and printed using a wide spaced accordion support with every layer rotation. As illustrated in FIG. 2A, the part 202 was a square about 45 mm×45 mm×5 mm deposited on top of a larger tower support 204. As further illustrated in FIG. 2A, the accordion support tower 204 had four spaces per large support layer extending along the full height of the tower 204. The part 202 and support tower 204 in FIG. 2B was printed using support layer spacing of 125 μm with rotations every support layer. With printing in this manner, 200 cm³ of printing material was eliminated from the support and the printing time was reduced by 45% with no loss of rigidity in the support. As illustrated in FIG. 2C, the accordion support tower printed with the aforementioned spacing and rotations exhibited excellent part 202 as evidenced by the patterning on the accordion support tower 204 with the part 202 removed.

### Example 2

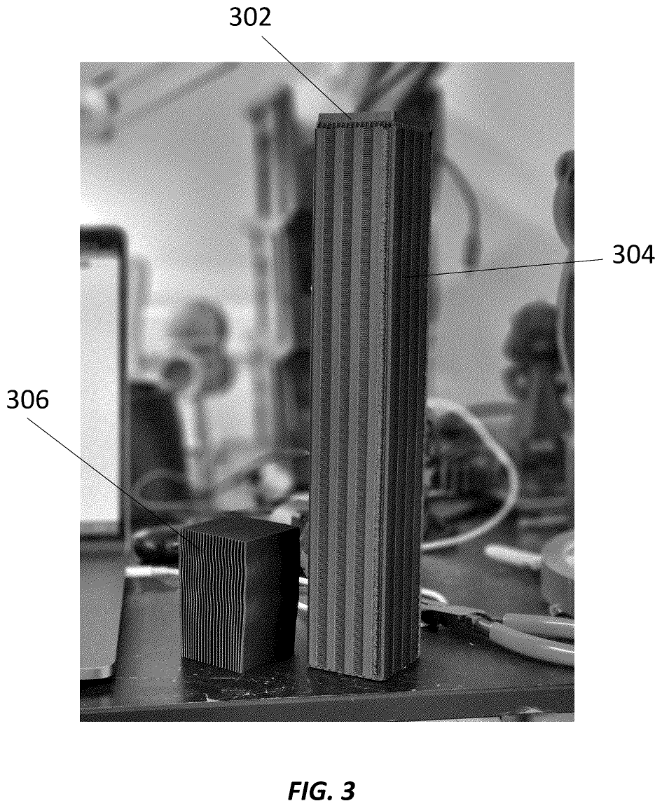

In this example, a square part was printed on top of a tower support. As illustrated in FIG. 3, the part 302 was a square about 45 mm×45 mm×5 mm deposited on top of a larger tower support 304. The tower support 304 was about 295 mm high and was printed using the spacing and layer rotations disclosed herein. As printed, the support tower 304 used about 72.2 cm³ of material and printed in 2.5 hours. As a comparison, a tower support of equivalent size using traditional printing methods would consume 284.1 cm³ of material and take 8 hours to print. As a further comparison, FIG. 3 illustrates a block of accordion support material 306 of the same material volume as the tower support 304 but printed using traditional support printing methods with closer, fixed dimension spacing. As is seen in FIG. 3, supports printed using the spacing and layer rotations disclosed herein represented significant material and time saving without loss of support function.

### Example 3

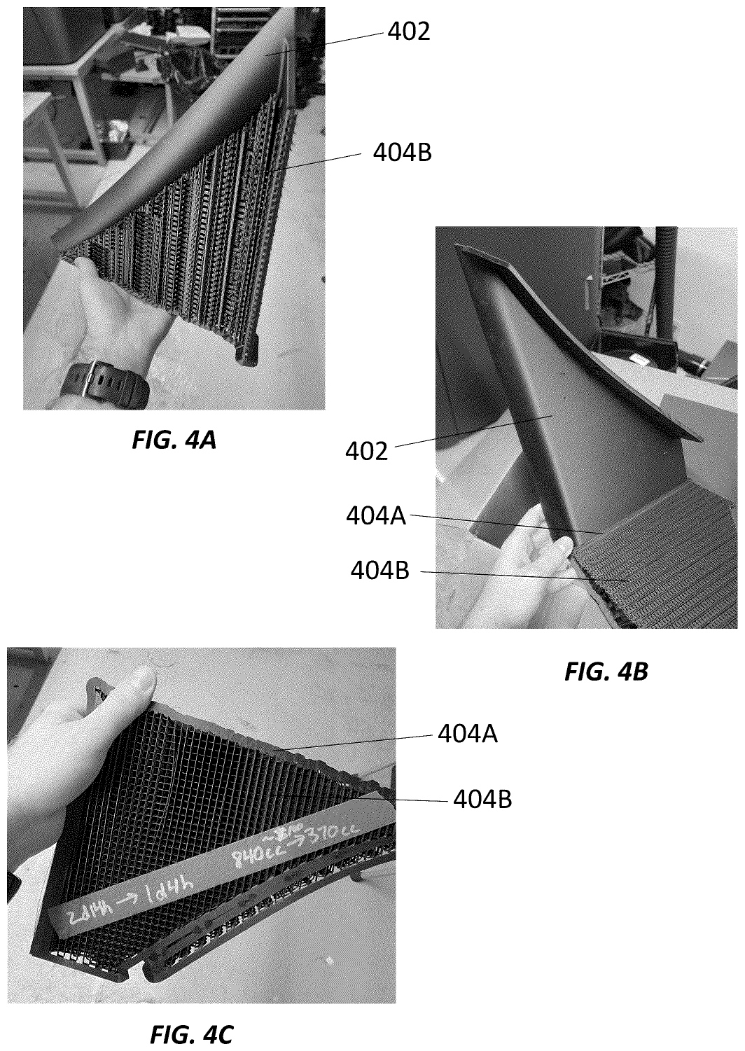

In this example, a part with both straight and curved surface was printed using supports made with both traditional printing methods and the printing methods of this disclosure. As illustrated in FIGS. 4A-4B, the support structure 404A, 404B against the curved surface of the part 402 had fine grained supports 404A close to the interface of the part and supports. The supports 404A, 404B increased in coarseness as the supports 404A, 404B were printed further from the part as seen in coarse support 404B. FIG. 4C illustrates the underside of the part 402 and supports 404A, 404B, showing a primarily coarse-spaced accordion-type support with solid edges. As compared to printing the same part with traditional support printing methods, the part 402 printed with supports 404A, 404B printed with methods of this disclosure used 370 cm³ of material for the supports compared to the 840 cm³ of material for traditional supports. Similarly, the printing time for the part 402 and supports 404A, 404B was reduced from 2 days, 14 hours to 1 day, 4 hours. As clearly seen, supports printed using the spacing and layer rotations disclosed herein represented significant material and time saving without loss of support function.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of printing a part with one or more supports, comprising:
receiving a representation of a part to be printed;
analyzing the representation along one or more of an X-Y plane, X-Z plane, and Y-Z plane to identify locations of the part where the one or more supports are needed;
depositing a first layer of the one or more supports at a first spacing;
depositing a second layer of the one or more supports at the first spacing;
repeating the deposition of additional layers of the one or more supports; and
printing the part onto the one or more supports.

2. The method of claim 1, wherein the first spacing is at least 1 mm.

3. The method of claim 2, wherein the first spacing is at least 8 mm.

4. The method of claim 1, wherein the first spacing is between 10 mm to 15 mm.

5. The method of claim 1, wherein a spacing of the one or more supports is decreased at an interface where the part is to be printed.

6. The method of claim 5, wherein the spacing of the one or more supports at the interface where the part is to be printed is at least 0.5 mm.

7. The method of claim 6, wherein the spacing of the one or more supports at the interface where the part is to be printed is between 0.5 mm and 10 mm.

8. The method of claim 7, wherein the spacing of the one or more supports at the interface where the part is to be printed is about 2.5 mm.

9. The method of claim 1, wherein the one or more supports have a layer thickness between 1 μm to 1000 μm.

10. The method of claim 9, wherein the one or more supports have a layer thickness between 50 μm to 500 μm.

11. The method of claim 1, wherein the second layer is rotated in a direction substantially orthogonal to the first layer of the one or more supports.

12. The method of claim 1, wherein the second layer is rotated in a direction between 0° to 90° relative to the first layer of the one or more supports.

13. The method of claim 12, wherein the second layer is rotated in a direction 45° relative to the first layer of the one or more supports.

14. The method of claim 11, wherein every successive layer is rotated in a direction between 0° to 90° relative to the previously deposited layer of the one or more supports.

15. The method of claim 1, wherein every successive layer is rotated in a direction substantially orthogonal to the first layer of the one or more supports.

16. A method of printing a part with one or more supports, comprising:
receiving a representation of a part to be printed;
analyzing the representation along one or more of an X-Y plane, X-Z plane, and Y-Z plane to identify locations of the part where the one or more supports are needed;
depositing a first layer of the one or more supports at a first spacing;
depositing a second layer of the one or more supports at the first spacing, the second layer rotated in a direction substantially orthogonal to the first layer of the one or more supports;
repeating the deposition of additional layers of the one or more supports, and
printing the part onto the one or more supports.

17. The method of claim 16, wherein a spacing of the one or more supports is decreased at an interface where the part is to be printed.

18. The method of claim 16, wherein the second layer is rotated in a direction orthogonal to the first layer of the one or more supports.

19. The method of claim 16, wherein every successive layer is rotated in a direction orthogonal to the previously deposited layer of the one or more supports.
